(19) United States
(12) Patent Application Publication
(10) Pub. No.: US 2021/0027218 A1
(43) Pub. Date: Jan. 28, 2021

(54) Variable Learning Rate System for Real Time Transaction Exception Sequencing In An Enterprise Computing Environment

(71) Applicant: Bank of America Corporation, Charlotte, NC (US)

(72) Inventors: Susheel Chiluka, Hyderabad (IN); Pushparaj Sathyanatha, Gurugram (IN); Kishore Kumar Selvapathy, Chennai (IN); Shally Behl, Gurugram (IN); Pavan Kusuma, Chennai (IN); Maitreya Sinha, Kolkata (IN)

(21) Appl. No.: 16/523,220

(22) Filed: Jul. 26, 2019

(51) Int. Cl. G06Q 10/06; G06N 20/00; G06N 5/04

(52) U.S. Cl. CPC G06Q 10/0635; G06N 5/04; G06N 20/00

(57) ABSTRACT

Aspects of the disclosure relate to dynamically analyzing data feeds to prioritize and execute actions. A computing platform may receive, from data feed source computer system(s), data feed source information. The computing platform may receive, from a data analyst computing system, risk prioritization information associated with the data feed source information. The computing platform may process, using an artificial intelligence data processing engine, the risk prioritization information to compute a weighted risk prioritization value. The computing platform may generate, using a dynamic analysis output module, based on the weighted risk prioritization value, an output command for the enterprise system(s), and transmit the output command to the enterprise system(s), which may cause the enterprise system(s) to execute at least one action associated with the data feed source information.

### BACKGROUND

Aspects of the disclosure relate to data processing, artificial intelligence, and computing systems. In particular, one or more aspects of the disclosure relate to a computing system within an enterprise computing environment that dynamically processes risk prioritization data in real time using artificial intelligence to control event delivery.

### SUMMARY

Aspects of the disclosure provide efficient, effective, scalable, and convenient technical solutions that address and overcome the technical problems associated with developing, implementing, operating, and maintaining a computer system that reliably processes risk prioritization data using real-time artificial intelligence and executes event delivery by providing systems, methods, and computer-readable media for dynamically analyzing data feeds to control execution of actions in an enterprise computing environment.

In accordance with one or more embodiments, a computing platform having at least one processor, a communication interface, and memory may receive, via the communication interface, from one or more data feed source computer systems, data feed source information. The computing platform may receive, via the communication interface, from a data analyst computing system, risk prioritization information associated with the data feed source information. The computing platform may process, using an artificial intelligence data processing engine, the risk prioritization to compute a weighted risk prioritization value. In some examples, the computing platform may assign and normalize a weighted distribution. The computing platform may generate, using a dynamic analysis output module, based on the weighted risk prioritization value, at least one output command for at least one enterprise system. The computing platform may transmit, via the communication interface, to the at least one enterprise system, the at least one output command generated for the at least one enterprise system, wherein transmitting the at least one output command generated for the at least one enterprise system to the at least one enterprise system causes the at least one enterprise system to execute at least one action associated with the data feed source information.

In some aspects, receiving the data feed source information from the one or more data feed source computer systems may include receiving financial data flow information, such as securities settlement information, from a financial data feed source computer system(s). In some examples, the computing platform may generate a real-time heat map providing a detailed risk assessment.

In some aspects, the computing platform may generate a second output command directing a second enterprise user computing device to present a notification generated by the dynamic analysis output module. Transmitting the at least one output command generated for the at least one enterprise system may include transmitting the second output command to the second enterprise user computing device. Transmitting the second output command to the second enterprise user computing device may cause the second enterprise user computing device to display the notification generated by the dynamic analysis output module.

In some aspects, generating the at least one output command for the at least one enterprise system may include generating a third output command directing a first enterprise user computing device to present a real-time dashboard generated by the dynamic analysis output module. In addition, transmitting the at least one output command generated for the at least one enterprise system may include transmitting the third output command to the first enterprise user computing device. Additionally, transmitting the third output command to the first enterprise user computing device may cause the first enterprise user computing device to display the real-time dashboard generated by the dynamic analysis output module.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for dynamically processing risk prioritization data and executing actions in accordance with one or more example embodiments;

FIG. 2 depicts an illustrative method for dynamically processing risk prioritization data and executing actions in an enterprise computing environment in accordance with one or more example embodiments;

FIGS. 3A and 3B illustrate an example of processing a data feed using artificial intelligence to prioritize data in an enterprise computing environment in accordance with one or more example embodiments; and

FIGS. 4A-4C illustrate examples of using artificial intelligence and/or machine learning for weighing parameters in an enterprise computing environment in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Securities settlements are a key function for many financial institutions. Settlements involve a number of functions, such as trade pre-matching, sufficiency management, and fails management for equities and debt in global markets. As a market practice, settlement analysts may contact their counterparts for any unmatched trades (“exceptions”) up until a trade actually settles. Prioritization of trades to manage settlement typically is manually performed based on a small number (e.g., two) of parameters. The current practice lacks an established process and system to define how exceptions should be prioritized. The current practice also lacks a systematic process to react quickly to market events and provide a new set of prioritized exceptions for settlements in order to minimize risk exposure.

Risk Priority Number (RPN) is a calculation often used to sort risks from highest to lowest. RPN may be calculated by multiplying factors such as severity, occurrence, and detection. For example, if the severity score is 6, the occurrence score is 4, and detection is 4, then the RPN is (6×4×4=) 96. The factors may be weighted such that RPN (Y) may be expressed as:

$$Y = {θ}_{1} {X}_{1} + {θ}_{2} {X}_{2} + {θ}_{3} {X}_{3} + … + {θ}_{m} {X}_{m}$$

$${X}_{i} \text{:} {i}^{t h} Factor$$

$${θ}_{i} \text{:} {i}^{t h} Weightage$$

$$Cost function \text{:} J = {\sum }_{j} {( h ( {X}^{j} ) - {Y}^{j} )}^{2}$$

$$h ( {X}^{j} ) = {\sum }_{i} {θ}_{i} * {X}_{i}^{j}$$

An optimization equation may be expressed as:

$$Repeat \{ \begin{matrix}\frac{\partial J ( {θ}_{i} )}{\partial {θ}_{i}} = ( h ( {X}^{j} ) - {Y}^{j} ) * {X}_{i}^{j} \\ {θ}_{i} = {θ}_{i} - ∝ * \frac{1}{m} * \frac{\partial J ( {θ}_{i} )}{\partial {θ}_{i}}\end{matrix} \}$$

This form of cost function provides a convex function in its domain, allowing gradient descent to converge to a global minima rather than converging at a local minima.

Aspects of the present disclosure include a computing platform featuring a prioritization engine and a smart dashboard, which may display the status of transactions and risk association for a given dataset using dynamic categories that may be continuously updated or built. The prioritization engine may prioritize source and target data across the queue using machine learning. The engine may promote reinforced learning, meaning that transaction matching may be driven completely by learned patterns while minimizing or avoiding manual intervention. The prioritization engine may, in real-time, identify modifications from a sponsoring enterprise organization and receive any status updates from other participating organizations and/or other sources. The prioritization engine may update risk scores in real-time, enabling an enterprise organization to manage risk more efficiently. A standardized approach may be implemented such that key parameters are considered for all queues and flows to determine the risk scores of a given transaction. This further improves efficiency by allowing end-users to focus on a smaller number of exceptions. The system may optimize itself solely on the current exceptions, without relying on historical data, thereby avoiding large computational workloads that can slow processing time.

In some aspects, the prioritization engine may compute a modified RPN using machine learning as illustrated in the following equations.

Existing learned model coefficients: {C₁, C₂, C₃, C₄. . . Cₘ}

Similarity function: J=Tanh(Σ(Cᵢ−θᵢ)²)

Optimization equation: For all i

[symbol]

{θᵢ=θᵢ+(Cᵢ−θᵢ)*J²*α}

{Cᵢ=θᵢ}

α=Stochastic learning rate.

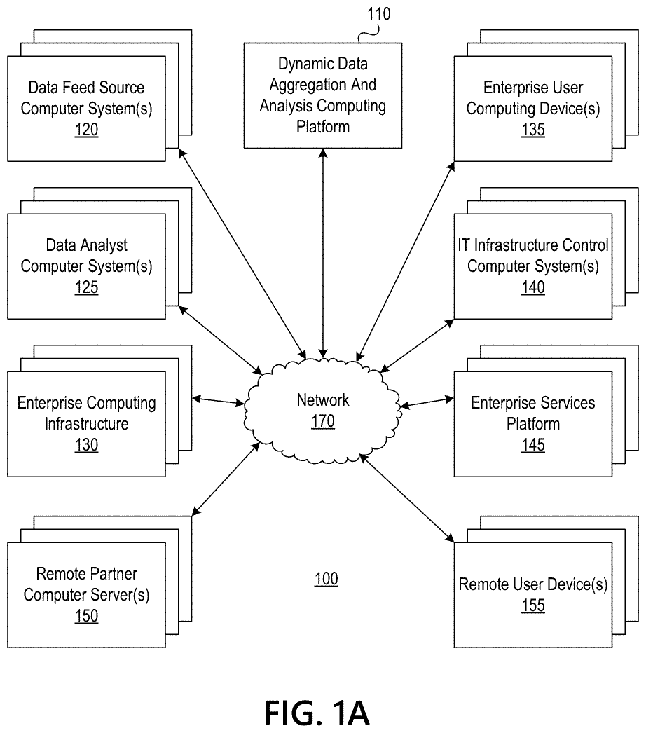

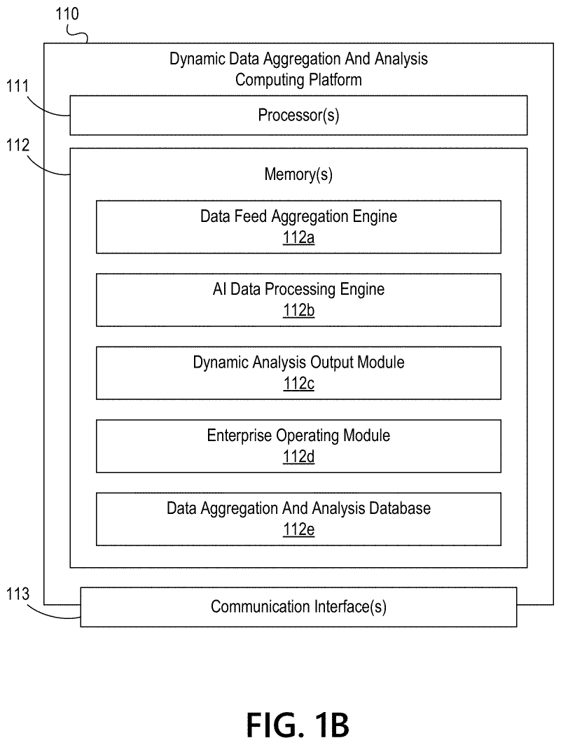

FIGS. 1A and 1B depict an illustrative computing environment for dynamically aggregating and analyzing distinct data feeds to predict and execute actions in accordance with one or more example embodiments. Referring to FIG. 1A, computing environment 100 may include one or more computer systems. For example, computing environment 100 may include a dynamic data aggregation and analysis computing platform 110, at least one data feed source computer system 120, at least one data analyst computer system 125, enterprise computing infrastructure 130, at least one enterprise user computing device 135, at least one information technology infrastructure control computer system 140, an enterprise services platform 145, at least one remote partner computer server 150, and at least one remote user device 155.

As illustrated in greater detail below, dynamic data aggregation and analysis computing platform 110 may include one or more computing devices configured to perform one or more of the functions described herein. For example, dynamic data aggregation and analysis computing platform 110 may include one or more computers (e.g., laptop computers, desktop computers, servers, server blades, or the like).

Data feed source computer system 120 may include one or more computing devices and/or other computer components (e.g., processors, memories, communication interfaces). In addition, and as illustrated in greater detail below, data feed source computer system 120 may be configured to gather, select, and/or send one or more real-time data feeds to dynamic data aggregation and analysis computing platform 110 and/or one or more other systems and/or devices in computing environment 100. In some instances, data feed source computer system 120 may be configured by dynamic data aggregation and analysis computing platform 110 to provide real-time data feeds to dynamic data aggregation and analysis computing platform 110 that include specific contents, such as real-time data feeds having information associated with financial activity, governmental regulations, and/or other activity.

Data analyst computer system 125 may be a personal computing device (e.g., desktop computer, laptop computer) or mobile computing device (e.g., smartphone, tablet) that may be linked to and/or used by a data analyst user (who may, e.g., be a data analyst or other administrative user of an organization operating dynamic data aggregation and analysis computing platform 110). Enterprise computing infrastructure 130 may include one or more computer servers, networks, platforms, and/or cloud-based services (which may, e.g., be used to support operations and/or other functions of an enterprise organization operating dynamic data aggregation and analysis computing platform 110, such as a financial institution). Enterprise user computing device 135 may be a personal computing device (e.g., desktop computer, laptop computer) or mobile computing device (e.g., smartphone, tablet) that may be linked to and/or used by an enterprise user (who may, e.g., be a client adviser, a customer service representative, an executive, or other employee or affiliate of an organization operating dynamic data aggregation and analysis computing platform 110).

Information technology infrastructure control computer system 140 may include one or more computing devices and/or other computer components (e.g., processors, memories, communication interfaces). In addition, and as illustrated in greater detail below, information technology infrastructure control computer system 140 may be configured to create, initialize, host, manage, and/or destroy broker connections between systems and/or devices included in computing environment 100. The information technology infrastructure control computer system 140 may, for instance, enable an organization operating dynamic data aggregation and analysis computing platform 110 to access and/or utilize cloud-based computing resources, including additional computing resources during times of high demand and/or when otherwise needed, for instance.

Enterprise services platform 145 may include one or more computing devices and/or other computer components (e.g., processors, memories, communication interfaces). In addition, and as illustrated in greater detail below, enterprise services platform 145 may be configured to host, serve, and/or otherwise provide one or more pages, dashboards, and/or other enterprise interfaces to other systems and/or devices included in computing environment 100. Such pages, dashboards, and/or other enterprise interfaces may, for instance, include information determined and/or generated by dynamic data aggregation and analysis computing platform 110 based on information received from data feed source computer system 120 and/or based on other information.

Remote partner computer server 150 may include one or more computing devices and/or other computer components (e.g., processors, memories, communication interfaces). In addition, and as illustrated in greater detail below, remote partner computer server 150 may be configured to receive, store, maintain, host, and/or provide information determined and/or generated by dynamic data aggregation and analysis computing platform 110 to one or more remote, external, and/or third-party systems and/or devices. Remote user device 155 may be a personal computing device (e.g., desktop computer, laptop computer) or mobile computing device (e.g., smartphone, tablet) that may be linked to and/or used by a remote, external, and/or third-party user (who might, e.g., not be associated with an organization operating dynamic data aggregation and analysis computing platform 110).

Computing environment 100 also may include one or more networks, which may interconnect one or more of dynamic data aggregation and analysis computing platform 110, data feed source computer system 120, data analyst computer system 125, enterprise computing infrastructure 130, enterprise user computing device 135, information technology infrastructure control computer system 140, enterprise services platform 145, remote partner computer server 150, and remote user device 155. For example, computing environment 100 may include a network 170 (which may, e.g., interconnect dynamic data aggregation and analysis computing platform 110, data feed source computer system 120, data analyst computer system 125, enterprise computing infrastructure 130, enterprise user computing device 135, information technology infrastructure control computer system 140, enterprise services platform 145, remote partner computer server 150, remote user device 155, and/or one or more other systems associated with an organization operating dynamic data aggregation and analysis computing platform 110, and/or one or more other systems, networks, sub-networks, and/or the like). In some examples, network 170 may be a private network such as an intranet.

In one or more arrangements, data analyst computer system 125, enterprise user computing device 135, remote user device 155, and/or the other systems included in computing environment 100 may be any type of computing device capable of receiving a user interface, receiving input via the user interface, and communicating the received input to one or more other computing devices. For example, data analyst computer system 125, enterprise user computing device 135, remote user device 155, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of dynamic data aggregation and analysis computing platform 110, data feed source computer system 120, data analyst computer system 125, enterprise computing infrastructure 130, enterprise user computing device 135, information technology infrastructure control computer system 140, enterprise services platform 145, remote partner computer server 150, and remote user device 155 may, in some instances, be special-purpose computing devices configured to perform specific functions.

Referring to FIG. 1B, dynamic data aggregation and analysis computing platform 110 may include one or more processors 111, memory 112, and communication interface 113. A data bus may interconnect processor 111, memory 112, and communication interface 113. Communication interface 113 may be a network interface configured to support communication between dynamic data aggregation and analysis computing platform 110 and one or more networks (e.g., network 170 or the like). Memory 112 may include one or more execution engines and/or program modules having instructions that when executed by processor 111 cause dynamic data aggregation and analysis computing platform 110 to perform one or more functions described herein and/or one or more databases that may store and/or otherwise maintain information which may be used by such execution engines, program modules, and/or processor 111. In some instances, the one or more execution engines, program modules, and/or databases may be stored by and/or maintained in different memory units of dynamic data aggregation and analysis computing platform 110 and/or by different computing devices that may form and/or otherwise make up dynamic data aggregation and analysis computing platform 110. For example, memory 112 may have, store, and/or include a data feed aggregation engine 112a, an artificial intelligence data processing engine 112b, a dynamic analysis output module 112c, an enterprise operating module 112d, and a data aggregation and analysis database 112e.

Data feed aggregation engine 112a may have instructions that direct and/or cause dynamic data aggregation and analysis computing platform 110 to receive, compile, and/or otherwise aggregate one or more data feeds (e.g., from data feed source computer system 120 and/or from one or more other systems and/or devices). Artificial intelligence data processing engine 112b may have instructions that direct and/or cause dynamic data aggregation and analysis computing platform 110 to use one or more artificial-intelligence-based algorithms and/or techniques to analyze, distill, and/or otherwise process information obtained from and/or otherwise associated the one or more data feeds aggregated by dynamic data aggregation and analysis computing platform 110. Dynamic analysis output module 112c may have instructions that direct and/or cause dynamic data aggregation and analysis computing platform 110 to generate, transmit, present, and/or otherwise provide one or more heat maps, notifications, and/or other outputs based on the processing performed by artificial intelligence data processing engine 112b and/or dynamic data aggregation and analysis computing platform 110. Enterprise operating module 112d may have instructions that direct and/or cause dynamic data aggregation and analysis computing platform 110 to send, serve, and/or otherwise communicate with enterprise services platform 145 and/or other systems and/or devices in computing environment 100 and/or perform other functions, including any and/or all of the functions described in greater detail below. Data aggregation and analysis database 112e may store information used by dynamic data aggregation and analysis computing platform 110 in dynamically aggregating and analyzing data feeds to prioritize and execute actions and/or in performing other functions.

As illustrated in greater detail below, by implementing and/or utilizing dynamic data aggregation and analysis computing platform 110 and/or the other systems included in computing environment 100, an organization may be able to sharpen its understanding of market events, including, but not limited to, assessing new and/or existing market risks and regulatory changes. In particular, such events may affect a financial institution operating dynamic data aggregation and analysis computing platform 110, the international financial system, and other organizations. As illustrated below, technology and artificial intelligence may allow an organization to process a significant amount of relevant data to more effectively and efficiently prioritize transactions.

In some arrangements, the functionality provided by dynamic data aggregation and analysis computing platform 110 may provide various benefits to various users, groups, and/or other entities. For instance, functionality provided by dynamic data aggregation and analysis computing platform 110 may provide senior executive leadership of an organization operating dynamic data aggregation and analysis computing platform 110 with a competitive advantage by delivering real time updates on indicia relevant to risk management. Additionally or alternatively, functionality provided by dynamic data aggregation and analysis computing platform 110 may be used by employees and/or affiliates of an organization operating dynamic data aggregation and analysis computing platform 110 to inform investment decisions and provide trend analysis. Additionally or alternatively, functionality provided by dynamic data aggregation and analysis computing platform 110 may be offered to clients of an organization operating dynamic data aggregation and analysis computing platform 110 to inform better investment decisions. Additionally or alternatively, functionality provided by dynamic data aggregation and analysis computing platform 110 may provide predictive models for compliance to anticipate regulatory developments. Additionally or alternatively, functionality provided by dynamic data aggregation and analysis computing platform 110 may provide information to a public policy team of an organization operating dynamic data aggregation and analysis computing platform 110 for relevant and timely analysis.

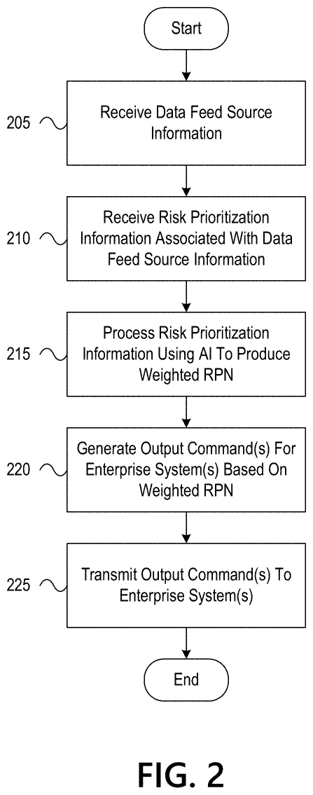

FIG. 2 depicts an illustrative method for dynamically analyzing data feeds to prioritize and execute actions in an enterprise computing environment in accordance with one or more example embodiments. Referring to FIG. 2, at step 205, a computing platform having at least one processor, a communication interface, and memory may receive, via the communication interface, from one or more data feed source computer systems, data feed source information. For example, at step 205, dynamic data aggregation and analysis computing platform 110 may receive, via a communication interface (e.g., communication interface 113), from one or more data feed source computer systems (e.g., data feed source computer system 120), data feed source information.

In some embodiments, receiving the data feed source information from the one or more data feed source computer systems may include receiving securities settlement information from at least one data feed source (e.g., financial institution) computer system. For example, in receiving the data feed source information from the one or more data feed source computer systems (e.g., data feed source computer system 120), dynamic data aggregation and analysis computing platform 110 may receive securities settlement information from at least one securities feed source computer system (which may, e.g., be one of data feed source computer system 120). The securities settlement information received from the at least one securities feed source computer system may include public and/or confidential information. Additionally or alternatively, the securities settlement information received from the at least one securities feed source computer system may include information identifying changes in governmental regulations, business rules, and/or other information. Additionally or alternatively, the securities settlement information received from the at least one securities feed source computer system may include one or more cryptocurrency activity feeds (which may, e.g., indicate flows and/or other transfers of various cryptocurrencies between various entities).

In some embodiments, receiving the data feed source information from the one or more data feed source computer systems may include receiving financial data flow information from at least one financial data feed source computer system. For example, in receiving the data feed source information from the one or more data feed source computer systems (e.g., data feed source computer system 120), dynamic data aggregation and analysis computing platform 110 may receive financial data flow information from at least one financial data feed source computer system (which may, e.g., be one of data feed source computer system 120). The financial data flow information received from the at least one financial data feed source computer system may include information identifying flows and/or other transfers of real currency between various entities (which may, e.g., include domestic transfers, international transfers, wire transfers, electronic transfers, and/or other types of transfers of funds). For instance, the financial data flow information received from the at least one financial data feed source computer system may include information associated with internal transfers (e.g., within a financial institution operating dynamic data aggregation and analysis computing platform 110), external funds transfers (e.g., from or to a second financial institution or other organization different from a first financial institution operating dynamic data aggregation and analysis computing platform 110, such as SWIFT data or the like).

In some embodiments, receiving the data feed source information from the one or more data feed source computer systems may include receiving market activity information from at least one market activity feed source computer system. For example, in receiving the data feed source information from the one or more data feed source computer systems (e.g., data feed source computer system 120), dynamic data aggregation and analysis computing platform 110 may receive market activity information from at least one market activity feed source computer system (which may, e.g., be one of data feed source computer system 120). The market activity information received from the at least one market activity feed source computer system may include information identifying market activity such as trading volume, market fluctuations, world events impacting securities trading, and/or other information. In some instances, such market activity information may be parsed, filtered, and/or otherwise obtained from live news feeds. In some instances, the market activity information received from the at least one market activity feed source computer system may include predictive market intelligence data (which may, e.g., indicate market activity that is predicted to occur but has not yet occurred; such a prediction may, e.g., be made by artificial intelligence data processing engine 112b).

At step 210, the computing platform may receive from data analyst computing system 125, risk prioritization information, e.g., information identifying an exception with respect to a risk prioritization number associated with the data feed source information. For example, at step 210, dynamic data aggregation and analysis computing platform 110 may aggregate, using a data feed aggregation engine (e.g., data feed aggregation engine 112a), the data feed source information received from the one or more data feed source computer systems (e.g., data feed source computer system 120) and information received from the data analyst computing system 125.

At step 215, the computing platform may process, using an artificial intelligence data processing engine, the aggregated data feed to produce a weighted risk prioritization number. For example, at step 215, dynamic data aggregation and analysis computing platform 110 may process, using an artificial intelligence data processing engine (e.g., artificial intelligence data processing engine 112b), the aggregated data feed to produce a weighted or adjusted risk prioritization number. In some instances, in processing the aggregated data feed, dynamic data aggregation and analysis computing platform 110 may provide additional tools and/or functionality, as described below in connection with various use cases.

At step 220, the computing platform may generate, using a dynamic analysis output module, based on the weighted or adjusted risk prioritization number, at least one output command for at least one enterprise system. For example, at step 220, dynamic data aggregation and analysis computing platform 110 may generate, using a dynamic analysis output module (e.g., dynamic analysis output module 112c), based on the weighted/adjusted risk prioritization number, at least one output command for at least one enterprise system (e.g., enterprise computing infrastructure 130, enterprise user computing device 135, information technology infrastructure control computer system 140, or enterprise services platform 145).

At step 225, the computing platform may transmit, via the communication interface, to the at least one enterprise system, the at least one output command generated for the at least one enterprise system. In addition, transmitting the at least one output command generated for the at least one enterprise system to the at least one enterprise system may cause the at least one enterprise system to execute at least one action associated with the data feed source information. For example, at step 225, dynamic data aggregation and analysis computing platform 110 may transmit, via the communication interface (e.g., communication interface 113), to the at least one enterprise system (e.g., enterprise computing infrastructure 130, enterprise user computing device 135, information technology infrastructure control computer system 140, or enterprise services platform 145), the at least one output command generated for the at least one enterprise system (e.g., enterprise computing infrastructure 130, enterprise user computing device 135, information technology infrastructure control computer system 140, or enterprise services platform 145). In addition, by transmitting the at least one output command generated for the at least one enterprise system (e.g., enterprise computing infrastructure 130, enterprise user computing device 135, information technology infrastructure control computer system 140, or enterprise services platform 145) to the at least one enterprise system (e.g., enterprise computing infrastructure 130, enterprise user computing device 135, information technology infrastructure control computer system 140, enterprise services platform 145), dynamic data aggregation and analysis computing platform 110 may cause the at least one enterprise system (e.g., enterprise computing infrastructure 130, enterprise user computing device 135, information technology infrastructure control computer system 140, enterprise services platform 145) to execute at least one action associated with the data feed source information. In some instances, in transmitting the at least one output command, dynamic data aggregation and analysis computing platform 110 may provide, via the at least one enterprise system, additional tools and/or functionality, as described below in connection with various use cases.

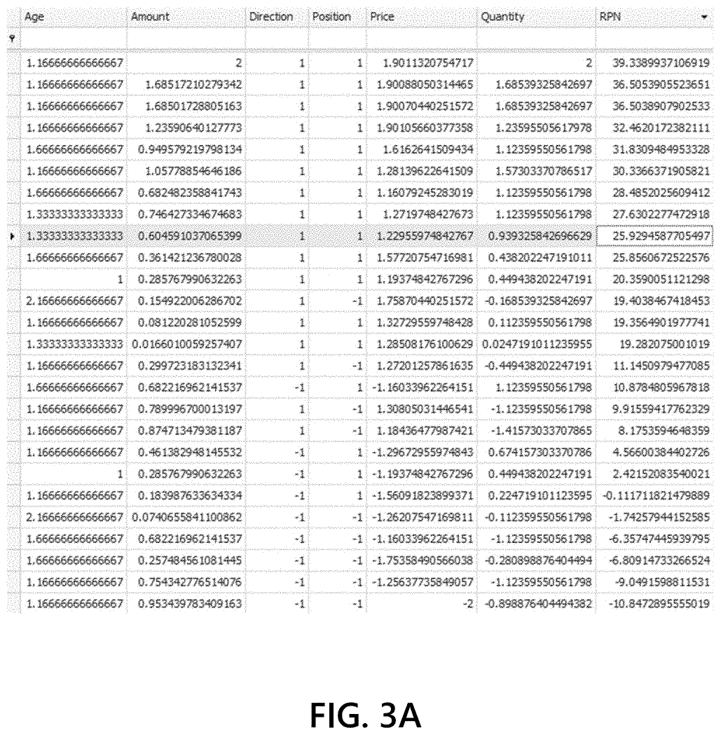

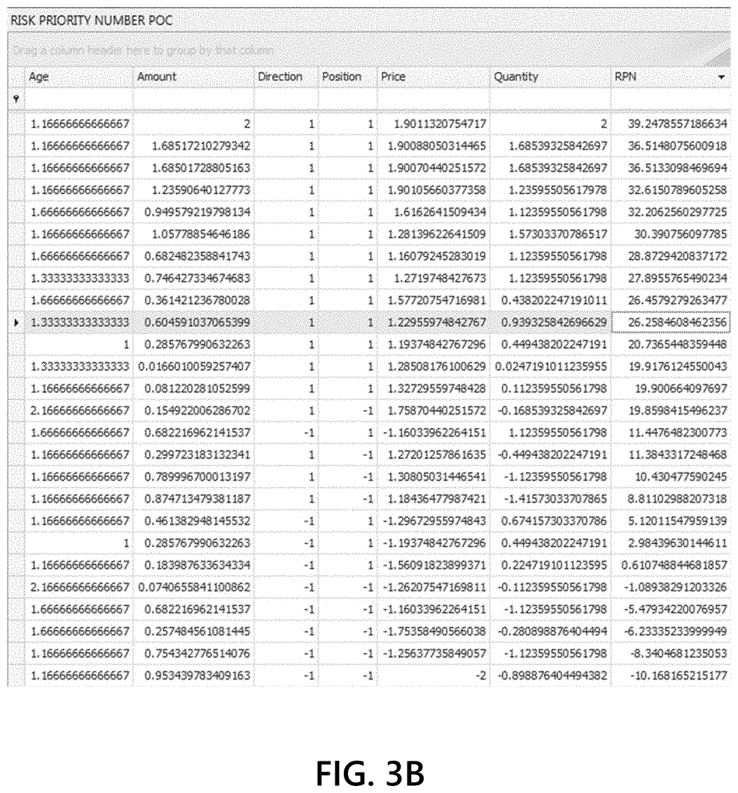

FIGS. 3A and 3B illustrate an example of prioritizing exceptions in a securities settlement context. In FIG. 3A, an operations analyst may resolve the highlighted exception.

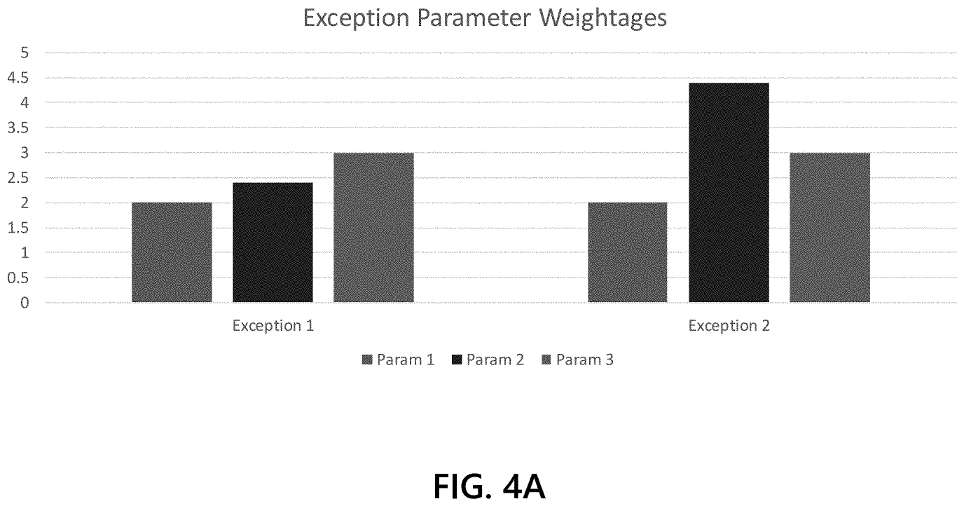

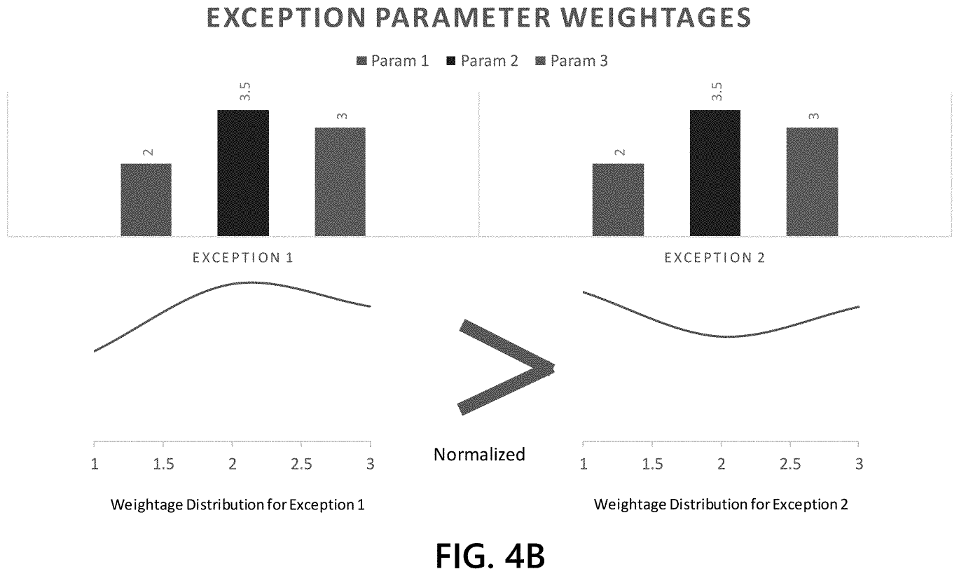

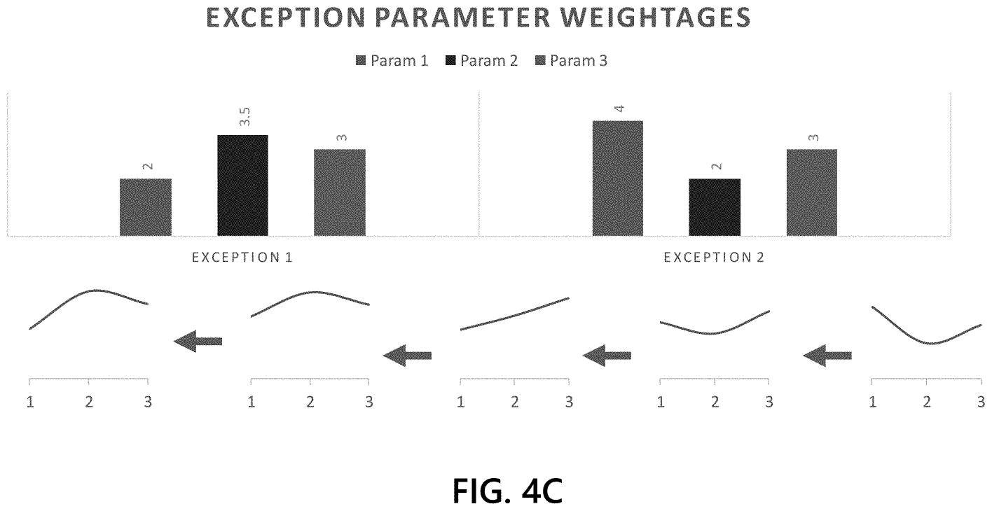

Because the analyst is going against the algorithm's current learned model, the dynamic data aggregation and analysis computing platform 110 reevaluates the data and, as illustrated in FIG. 4B, computes a weighted risk prioritization number (RPN). In the example shown, RPN increased relative to the original value and this weighted RPN is used for completing the settlement.

FIGS. 4A-4C illustrate examples of weighing and normalizing exception parameters. FIG. 4A shows an example involving two exceptions each having three parameters, where parameters 1 and 3 are at the same level for each exception and parameter 2 is higher for the second exception relative to that of the first exception. Because of this relationship, exception 2 is given a higher rank than exception 1. In the example shown in FIG. 4B, exception 1 and exception 2 have the same values; and so the exception which has a parameter distribution pattern more similar to the weightage profile is assigned a higher risk score. As shown in FIG. 4C, because the dynamic data aggregation and analysis computing platform 110 starts with exception 2 as the higher score (rightmost weightage profile), if a user continues selecting exception 1 as the top priority, then the dynamic data aggregation and analysis computing platform 110 may automatically learn and change the weightage profile to the leftmost whereupon exception 1 is given priority over exception 2. The learning rate controls the speed of adaption to the changes, which may be influenced by market events.

In some embodiments, generating the at least one output command for the at least one enterprise system may include generating a second output command directing a second enterprise user computing device to present a notification generated by the dynamic analysis output module based on the data feed source information and/or adjusted RPN. In addition, transmitting the at least one output command generated for the at least one enterprise system may include transmitting the second output command to the second enterprise user computing device. Additionally, transmitting the second output command to the second enterprise user computing device may cause the second enterprise user computing device to display the notification generated by the dynamic analysis output module. For example, in generating the at least one output command for the at least one enterprise system (e.g., enterprise computing infrastructure 130, enterprise user computing device 135, information technology infrastructure control computer system 140, or enterprise services platform 145), dynamic data aggregation and analysis computing platform 110 may generate a second output command directing a second enterprise user computing device (e.g., enterprise user computing device 135) to present a notification generated by the dynamic analysis output module (e.g., dynamic analysis output module 112c). In addition, in transmitting the at least one output command generated for the at least one enterprise system (e.g., enterprise computing infrastructure 130, enterprise user computing device 135, information technology infrastructure control computer system 140, or enterprise services platform 145), dynamic data aggregation and analysis computing platform 110 may transmit the second output command to the second enterprise user computing device (e.g., enterprise user computing device 135). Additionally, by transmitting the second output command to the second enterprise user computing device (e.g., enterprise user computing device 135), dynamic data aggregation and analysis computing platform 110 may cause the second enterprise user computing device (e.g., enterprise user computing device 135) to display the notification generated by the dynamic analysis output module (e.g., dynamic analysis output module 112c).

In some embodiments, generating the at least one output command for the at least one enterprise system may include generating a third output command directing an enterprise services platform to serve one or more dashboard pages based on the data feed source information and/or adjusted RPN. In addition, transmitting the at least one output command generated for the at least one enterprise system may include transmitting the third output command to the enterprise services platform. Additionally, transmitting the third output command to the enterprise services platform may cause the enterprise services platform to serve the one or more dashboard pages. For example, in generating the at least one output command for the at least one enterprise system (e.g., enterprise computing infrastructure 130, enterprise user computing device 135, information technology infrastructure control computer system 140, or enterprise services platform 145), dynamic data aggregation and analysis computing platform 110 may generate a third output command directing an enterprise services platform (e.g., enterprise services platform 145) to serve one or more dashboard pages. In addition, in transmitting the at least one output command generated for the at least one enterprise system (e.g., enterprise computing infrastructure 130, enterprise user computing device 135, information technology infrastructure control computer system 140, or enterprise services platform 145), dynamic data aggregation and analysis computing platform 110 may send the third output command to the enterprise services platform (e.g., enterprise services platform 145). Additionally, by transmitting the third output command to the enterprise services platform (e.g., enterprise services platform 145), dynamic data aggregation and analysis computing platform 110 may cause the enterprise services platform (e.g., enterprise services platform 145) to serve the one or more dashboard pages based on the data feed source information and/or adjusted RPN.

Dynamic data aggregation and analysis computing platform 110 may generate a real-time heat map, which may be provided to one or more other systems and/or devices included in computing environment 100, such as enterprise user computing device 135, which may display and/or otherwise present the real-time heat map. In addition to providing a detailed assessment of risks, dynamic data aggregation and analysis computing platform 110 also may predict outcomes using different data feeds (e.g., obtained from data feed source computer system 120), artificial intelligence (e.g., provided by artificial intelligence data processing engine 112b), and information obtained from analysis provided by international experts. By manipulating one or more user-selectable options of the one or more graphical user interfaces, a user (who may, e.g., be using enterprise user computing device 135 to interact with the real-time heat map) may choose from a set of variables providing insight into possible effects of future events. In some instances, the real-time heat map and/or other features provided by dynamic data aggregation and analysis computing platform 110 may factor in and visualize new threats. Additionally or alternatively, the real-time heat map and/or other features provided by dynamic data aggregation and analysis computing platform 110 may factor in and/or identify risks deriving from migration movements, anomalies in money flows, or unauthorized re-routing of funds.

In some instances, dynamic data aggregation and analysis computing platform 110 may gather and process in-house data (e.g., which may be available to an organization operating dynamic data aggregation and analysis computing platform 110) such as macroeconomic data, financial data, risk assessment data, financial flow data, cyber threat intelligence data, and/or other types of data. In addition, dynamic data aggregation and analysis computing platform 110 may gather and process data that is available from one or more partner institutions. In addition, dynamic data aggregation and analysis computing platform 110 may gather and process data that is provided by one or more international teams of risk analysis experts.

By defining assumptions and selecting the right model, dynamic data aggregation and analysis computing platform 110 may better utilize available technology resources and data to define risks and predict future developments. In some instances, models may be combined to shape the underlying logic that runs the platform utilized by dynamic data aggregation and analysis computing platform 110. For instance, to avoid analogy traps, dynamic data aggregation and analysis computing platform 110 may utilize processing that is based on first principle reasoning while accounting for game theory concepts to predict future events. In some instances, dynamic data aggregation and analysis computing platform 110 also may use neuro-network maps that assist in deciphering the interconnectedness of events. The dynamic data aggregation and analysis computing platform 110 may utilize mathematical modeling, AI capability, and insights from neuroscience, psychology, political science and sociology in evaluating models (which may, e.g., be continuously assessed and iteratively improved) and generating predictions. In addition, an AI component of dynamic data aggregation and analysis computing platform 110 may improve the performance of dynamic data aggregation and analysis computing platform 110 over time by adjusting variables, evaluating user preferences, and learning how to better predict future events.

In one or more arrangements, dynamic data aggregation and analysis computing platform 110 may combine different layers of data, both quantitative and qualitative, and extrapolate trends and outliers to predict future risks. Using AI processing may improve the reliability of predictions made by dynamic data aggregation and analysis computing platform 110 over time.

In one or more arrangements, the features, outputs, and/or other aspects provided by dynamic data aggregation and analysis computing platform 110 may be customizable and may allow tiered access to various components (e.g., of applications, output data, and/or predictive modeling analysis used by dynamic data aggregation and analysis computing platform 110). In some instances, user interfaces may be provided to dynamic data aggregation and analysis computing platform 110 via enterprise solutions and/or mobile applications. The application experience may enable a user of dynamic data aggregation and analysis computing platform 110 to control input and determine outcomes based on various data feeds (which may, e.g., be manipulated by the user). In addition, certain features of dynamic data aggregation and analysis computing platform 110 may be designed for and/or customized for different users. For instance, some features of dynamic data aggregation and analysis computing platform 110 may be customized for executives to provide senior leadership of an organization with a competitive advantage by delivering real-time updates on risk and predictive modeling. Additionally or alternatively, some features of dynamic data aggregation and analysis computing platform 110 may be customized for investment personnel to provide a matrix of investment research data and analysis with real-time data feeds to inform investment decisions and provide trend analysis. Additionally or alternatively, some features of dynamic data aggregation and analysis computing platform 110 may be customized for certain clients (who may, e.g., be interested in investing) as tools associated with dynamic data aggregation and analysis computing platform 110 may serve as a differentiator in the market by providing a service that supports better investment decisions.

Additionally or alternatively, some features of dynamic data aggregation and analysis computing platform 110 may be customized for compliance personnel (e.g., predictive models may help compliance personnel to anticipate regulatory developments). Additionally or alternatively, some features of dynamic data aggregation and analysis computing platform 110 may be customized for security personnel (e.g., intelligent risk analysis may help to identify cyber threats and/or unauthorized activity). Additionally or alternatively, some features of dynamic data aggregation and analysis computing platform 110 may be customized for public policy personnel (e.g., outputs provided by dynamic data aggregation and analysis computing platform 110 may inform and drive organization policy decisions and strategic alliances).

In some instances, dynamic data aggregation and analysis computing platform 110 and/or one or more other aspects of the disclosure may be used in market investment banking use cases. For instance, dynamic data aggregation and analysis computing platform 110 may provide one or more market investment mapping tools, which may access and/or display investment-specific information associated with logistics and supplies, investment-specific information associated with market fluctuations, and/or investment-specific information associated with risk.

In some instances, the one or more market investment mapping tools provided by dynamic data aggregation and analysis computing platform 110 may be connected to a research library service (which may, e.g., enable traders to view historical trends in stocks and/or other assets). In addition, dynamic data aggregation and analysis computing platform 110 may provide one or more market investment banking tools, which may be associated with specific investor profiles and/or portfolios. For instance, data maintained, manipulated, and/or otherwise used by dynamic data aggregation and analysis computing platform 110 may be tagged to highlight media which may impact market investments, policy which may impact traditional-market investments, and/or current events which may impact market investments. Additionally, dynamic data aggregation and analysis computing platform 110 may provide search tools that may enable a user of dynamic data aggregation and analysis computing platform 110 to access reports on market overviews, policy reports, and/or reports identifying current and/or previous organization market investments. Dynamic data aggregation and analysis computing platform 110 also may provide a repository to store market investment notes and searches (which may, e.g., enable a user of dynamic data aggregation and analysis computing platform 110 to save a particular trend line and/or search for future use).

In some instances, dynamic data aggregation and analysis computing platform 110 and/or one or more other aspects of the disclosure may be used in emerging market investment banking use cases. For instance, dynamic data aggregation and analysis computing platform 110 may provide one or more emerging-market investment mapping tools, which may access and/or display investment-specific information associated with one or more auctions, investment-specific information associated with project options, investment-specific information associated with logistics and supplies, investment-specific information associated with market fluctuations, investment-specific information associated with risk, investment-specific information associated with one or more company profiles, and/or investment-specific information associated with one or more people profiles. In some instances, the one or more emerging-market investment mapping tools provided by dynamic data aggregation and analysis computing platform 110 may be connected to a research library service (which may, e.g., enable traders to view historical trends in stocks and/or other assets). In addition, dynamic data aggregation and analysis computing platform 110 may provide one or more emerging-market investment banking tools, which may be associated with specific investor profiles and/or portfolios. For instance, data maintained, manipulated, and/or otherwise used by dynamic data aggregation and analysis computing platform 110 may be tagged to highlight media which may impact emerging-market investments, policy which may impact emerging-market investments, and/or current events which may impact emerging-market investments. Additionally, dynamic data aggregation and analysis computing platform 110 may provide search tools that may enable a user of dynamic data aggregation and analysis computing platform 110 to access reports on market overviews, policy reports, and/or reports identifying current and/or previous organization emerging-market investments. Dynamic data aggregation and analysis computing platform 110 also may provide a repository to store emerging-market investment notes and searches (which may, e.g., enable a user of dynamic data aggregation and analysis computing platform 110 to save a particular trend line and/or search for future use).

In some instances, investment banking functionalities provided by dynamic data aggregation and analysis computing platform 110 may be licensed to and/or otherwise provided to investment banking clients. Additionally or alternatively, dynamic data aggregation and analysis computing platform 110 and/or artificial intelligence data processing engine 112b may generate recommendations on investment banking decisions based on automated data analysis (e.g., to buy and/or sell certain securities and/or other assets). For instance, dynamic data aggregation and analysis computing platform 110 may be configured to make automated trades based on its automated data analysis (e.g., if such trades are within predefined parameters, such as buying or selling less than a predetermined amount of securities and/or other assets, upon resolution of any exceptions). In some instances, recommendations generated by dynamic data aggregation and analysis computing platform 110 and/or artificial intelligence data processing engine 112b may tie into other systems, such as early warning systems that may generate alerts associated with executive travel and/or the relocation of human resources, technology infrastructure, capital, and/or the like. In some instances, dynamic data aggregation and analysis computing platform 110 may execute and/or otherwise utilize one or more machine learning models, which may learn severity levels of different events, thus enabling dynamic data aggregation and analysis computing platform 110 to generate alerts that are associated with machine-learned severity levels. In some instances, in addition to generating and/or sending alerts to internal users (who may, e.g., be employees of and/or otherwise associated with an organization operating dynamic data aggregation and analysis computing platform 110), dynamic data aggregation and analysis computing platform 110 also may generate and/or send alerts to external users (who may, e.g., be customers of and/or otherwise not associated with an organization operating dynamic data aggregation and analysis computing platform 110). For instance, dynamic data aggregation and analysis computing platform 110 may provide customer-alerts indicating that customers should avoid visiting banking centers and/or other locations in certain areas due to temporary events and/or risks (e.g., natural disasters, unrest, or the like). In some instances, alerts provided by dynamic data aggregation and analysis computing platform 110 may tie into an organization's customer-facing mobile application, automated assistant application, and/or the like.

As another example, in a client-facing use case, dynamic data aggregation and analysis computing platform 110 and/or one or more other aspects of the disclosure may be used to present risk and investment information to particular clients of an organization operating dynamic data aggregation and analysis computing platform 110. For instance, the heat map function of dynamic data aggregation and analysis computing platform 110, discussed above, may be used to highlight increased risk and market activity and/or may include tacks to pin key client investments and/or concerns. In addition, dynamic data aggregation and analysis computing platform 110 may provide an RSS feed for alerts concerning critical policy changes and high risk events. Using the interactive map features associated with the heat map, a client accessing one or more interfaces generated by dynamic data aggregation and analysis computing platform 110 may be able to select a country or region to access information indicative of recent events, market overviews, and policy updates. In addition, one or more of the user interfaces generated by dynamic data aggregation and analysis computing platform 110 may be mobile accessible and/or optimized for display on a mobile device. Such features may, for instance, enable client-driven reviews for personal investments and/or may provide access to organizational research and geopolitical data to drive client investment opportunities.

As another example, in a compliance and/or legal use case, dynamic data aggregation and analysis computing platform 110 and/or one or more other aspects of the disclosure may be used to provide and/or present data associated with pending and/or enacted global policy changes. For instance, the heat map function of dynamic data aggregation and analysis computing platform 110, discussed above, may be used to highlight increased risk and market activity and may include a search function to highlight current and pending policy changes. In addition, dynamic data aggregation and analysis computing platform 110 may provide an RSS feed for early warning alerts concerning critical changes and high risk events with tailored focus on laws, rules, and regulations. Further, dynamic data aggregation and analysis computing platform 110 may provide a searchable repository of draft and/or final policy documents, and one or more hyperlinks may be provided in the interfaces generated by dynamic data aggregation and analysis computing platform 110 to key regional contacts for compliance, legal, and/or regulatory support.

In some instances, in compliance and/or legal use cases, dynamic data aggregation and analysis computing platform 110 may maintain a repository of policy documents, which may enable an enterprise organization operating dynamic data aggregation and analysis computing platform 110 to access documents associated with laws, regulations, and/or rules that may be impact operational capabilities of the enterprise organization in a given location and/or at a given time. Information obtained from the repository maintained by dynamic data aggregation and analysis computing platform 110 also may be used in risk evaluations executed by dynamic data aggregation and analysis computing platform 110, such as automated risk evaluations executed by dynamic data aggregation and analysis computing platform 110 that assess whether to maintain an operational presence in a certain location after specific changes have been made in the location's legal and/or regulatory environment. In some instances, dynamic data aggregation and analysis computing platform 110 also may maintain historical artifacts associated with such risk evaluations (which may, e.g., be used in future risk evaluations for the same location and/or other locations).

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, from one or more data feed source computer systems, data feed source information;
receive, via the communication interface, from a data analyst computing system, risk prioritization information associated with the data feed source information;
process, using an artificial intelligence data processing engine, the risk prioritization information to compute a weighted risk prioritization value;
generate, using a dynamic analysis output module, based on the weighted risk prioritization value, at least one output command for at least one enterprise system; and
transmit, via the communication interface, to the at least one enterprise system, the at least one output command generated for the at least one enterprise system, wherein transmitting the at least one output command generated for the at least one enterprise system to the at least one enterprise system causes the at least one enterprise system to execute at least one action associated with the data feed source information.

2. The computing platform of claim 1, wherein receiving the data feed source information from the one or more data feed source computer systems comprises receiving financial data flow information from at least one financial data feed source computer system.

3. The computing platform of claim 2, wherein receiving the data feed source information from the one or more data feed source computer systems comprises receiving securities settlement information from at least one securities data feed source computer system.

4. The computing platform of claim 1, wherein generating the at least one output command for the at least one enterprise system comprises generating a real-time heat map providing detailed risk assessment.

5. The computing platform of claim 1, wherein processing the risk prioritization information includes assigning a weighted distribution and normalizing the weighted distribution.

6. The computing platform of claim 1, wherein generating the at least one output command for the at least one enterprise system comprises generating a second output command directing a second enterprise user computing device to present a notification generated by the dynamic analysis output module,
wherein transmitting the at least one output command generated for the at least one enterprise system comprises transmitting the second output command to the second enterprise user computing device, and
wherein transmitting the second output command to the second enterprise user computing device causes the second enterprise user computing device to display the notification generated by the dynamic analysis output module.

7. The computing platform of claim 1, wherein generating the at least one output command for the at least one enterprise system comprises generating a third output command directing an enterprise services platform to serve one or more dashboard pages,
wherein transmitting the at least one output command generated for the at least one enterprise system comprises transmitting the third output command to the enterprise services platform, and
wherein transmitting the third output command to the enterprise services platform causes the enterprise services platform to serve the one or more dashboard pages based on the data feed source information.

8. A method, comprising:
at a computing platform comprising at least one processor, a communication interface, and memory:
receiving, via the communication interface, from one or more data feed source computer systems, data feed source information;
receiving, via the communication interface, from a data analyst computing system, risk prioritization information associated with the data feed source information;
processing, using an artificial intelligence data processing engine, the risk prioritization information to produce a weighted risk prioritization value;
generating, using a dynamic analysis output module, based on the weighted risk prioritization value, at least one output command for at least one enterprise system; and
transmitting, via the communication interface, to the at least one enterprise system, the at least one output command generated for the at least one enterprise system, wherein transmitting the at least one output command generated for the at least one enterprise system to the at least one enterprise system causes the at least one enterprise system to execute at least one action associated with the data feed source information.

9. The method of claim 8, wherein receiving the data feed source information from the one or more data feed source computer systems comprises receiving financial data flow information from at least one financial data feed source computer system.

10. The method of claim 9, wherein receiving the data feed source information from the one or more data feed source computer systems comprises receiving securities settlement information from at least one securities data feed source computer system.

11. The method of claim 8, wherein generating the at least one output command for the at least one enterprise system comprises generating a real-time heat map providing detailed risk assessment.

12. The method of claim 8, wherein processing the risk prioritization information includes assigning a weighted distribution and normalizing the weighted distribution.

13. The method of claim 8, wherein generating the at least one output command for the at least one enterprise system comprises generating a second output command directing a second enterprise user computing device to present a notification generated by the dynamic analysis output module,
wherein transmitting the at least one output command generated for the at least one enterprise system comprises transmitting the second output command to the second enterprise user computing device, and
wherein transmitting the second output command to the second enterprise user computing device causes the second enterprise user computing device to display the notification generated by the dynamic analysis output module.

14. The method of claim 8, wherein generating the at least one output command for the at least one enterprise system comprises generating a third output command directing an enterprise services platform to serve one or more dashboard pages,
wherein transmitting the at least one output command generated for the at least one enterprise system comprises transmitting the third output command to the enterprise services platform, and
wherein transmitting the third output command to the enterprise services platform causes the enterprise services platform to serve the one or more dashboard pages based on the data feed source information.

15. One or more non-transitory computer-readable media storing instructions that, when executed by a computing platform comprising at least one processor, a communication interface, and memory, cause the computing platform to:
receive, via the communication interface, from one or more data feed source computer systems, data feed source information;
receive, via the communication interface, from a data analyst computing system, risk prioritization information associated with the data feed source information;
process, using an artificial intelligence data processing engine, the risk prioritization information to compute a weighted risk prioritization value;
generate, using a dynamic analysis output module, based on the weighted risk prioritization value, at least one output command for at least one enterprise system; and
transmit, via the communication interface, to the at least one enterprise system, the at least one output command generated for the at least one enterprise system, wherein transmitting the at least one output command generated for the at least one enterprise system to the at least one enterprise system causes the at least one enterprise system to execute at least one action associated with the data feed source information.

16. The one or more non-transitory computer-readable media of claim 15, wherein receiving the data feed source information from the one or more data feed source computer systems comprises receiving financial data flow information from at least one financial data feed source computer system.

17. The one or more non-transitory computer-readable media of claim 16, wherein receiving the data feed source information from the one or more data feed source computer systems comprises receiving securities settlement information from at least one securities data feed source computer system.

18. The one or more non-transitory computer-readable media of claim 15, wherein processing the risk prioritization information includes assigning a weighted distribution and normalizing the weighted distribution.

19. The one or more non-transitory computer-readable media of claim 15, wherein generating the at least one output command for the at least one enterprise system comprises generating a second output command directing a second enterprise user computing device to present a notification generated by the dynamic analysis output module,
wherein transmitting the at least one output command generated for the at least one enterprise system comprises transmitting the second output command to the second enterprise user computing device, and
wherein transmitting the second output command to the second enterprise user computing device causes the second enterprise user computing device to display the notification generated by the dynamic analysis output module.

20. The one or more non-transitory computer-readable media of claim 15, wherein generating the at least one output command for the at least one enterprise system comprises generating a third output command directing an enterprise services platform to serve one or more dashboard pages,
wherein transmitting the at least one output command generated for the at least one enterprise system comprises transmitting the third output command to the enterprise services platform, and
wherein transmitting the third output command to the enterprise services platform causes the enterprise services platform to serve the one or more dashboard pages based on the data feed source information.
